(19) United States
(12) Patent Application Publication
(10) Pub. No.: US 2009/0316976 A1
(43) Pub. Date: Dec. 24, 2009

(54) Complexity-based analysis of cellular flickering

(76) Inventors: Madalena Damasio Costa, Boston, MA (US); Ionita Ghiran, Boston, MA (US); Chung-Kang Peng, Boston, MA (US); Anne Nicholson-Weller, Boston, MA (US); Ary L. Goldberger, Boston, MA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/457,480

(22) Filed: Jun. 12, 2009

Related U.S. Application Data
(60) Provisional application No. 61/129,256, filed on Jun. 13, 2008.

(51) Int. Cl. G06K 9/00

(52) U.S. Cl. 382/133

(57) ABSTRACT

Provided herein are methods and systems for assessing cellular flickering. The methods include using a phase contrast microscope to obtain a plurality of images of a cell, digitizing and/or pixilating the plurality of images such that the plurality of images are segmented into an array of pixels, each pixel representing a portion of the cell, and measuring the fluctuations in the pixel intensities. The methods further include calculating a complexity measure for the individual pixels based on the measured fluctuations of the portions of the cell represented by the individual pixels. Such complexity measures can then be mapped and/or plotted in order to assess cellular flickering, and thereby assess biological function and other characteristics of the cell.

### CROSS REFERENCE TO RELATED APPLICATIONS

This application claims the benefit of U.S. Provisional Appl. No. 61/129,256, filed Jun. 13, 2008.

### STATEMENT REGARDING FEDERALLY-SPONSORED RESEARCH AND DEVELOPMENT

Part of the work performed during development of this invention utilized U.S. Government funds. The U.S. Government has certain rights in this invention.

### BACKGROUND OF THE INVENTION

1. Field of the Invention

The present invention relates generally to methods and systems for assessing and analyzing cellular flickering, and applications for the use of cellular flickering measurements.

2. Background Art

Human blood contains three major formed (cellular) components: red blood cells (RBCs), white blood cells (leukocytes) and platelets. Cells, and RBCs specifically, have been found to exhibit vibratory motions, referred to as “flickering.” The maximum amplitude of RBC flickering has been reported to be on the order of 0.4 μm, i.e., approximately 5% of the average RBC diameter (˜7.5 μm). Studies have reported values of the overall frequency of RBC flickering to range from 0.2 to 30 Hz. The phenomenon of flickering was initially attributed solely to thermal fluctuations. Recent studies, however, have demonstrated that flickering involves actin protofilaments and is driven by metabolic energy (ATP). These findings raise the possibility that flickering has a complex temporal structure and a biologic role.

Generally, the physiologic systems of a living organism generate complex fluctuations in their output signals. The complex fluctuations (also referred to as “complexity”) arise from the interaction of a myriad of structural units and regulatory feedback loops that operate over a wide range of temporal and spatial scales. This interaction reflects the organism's ability to adapt to environmental and physiological stresses. Being able to quantify or model the physiologic complexity of an organism provides insight into the underlying dynamics and physiological state of the organism.

For example, a decrease in physiologic complexity can be symptomatic of a pathologic process. Under free-running conditions, a sustained decrease in complexity generally reflects a reduced ability of an organism to function in certain dynamical regimes, possibly due to decoupling or degradation of control mechanisms. As such, a loss of complexity is generally a fundamental and consistent marker of adverse effects (including pathology and age-related degenerative changes) on an organism. An increase in complexity generally indicates a potentially therapeutic or healthful effect on an organism.

U.S. Patent Application Publication No. 2006/0189875, which is incorporated herein by reference, teaches a complexity-based dynamical assay for assessing the toxicity and efficacy of pharmaceutical and other therapeutic interventions.

For further background on the topics discussed herein, reference is made to the following publications:
Waugh, et al., Rheologic properties of senescent erythrocytes: loss of surface area and volume with red blood cell age, Blood 79, 1351-1358 (1992).
Linderkamp, et al., Deformability of density separated red blood cells in normal newborn infants and adults, Pediatr. Res. 16, 964-968 (1982).
V. L. Lew, et al., Effects of age-dependent membrane transport changes on the homeostasis of senescent human red blood cells, Blood 110, 1334-1342 (2007).
Blowers, et al., Flicker phenomenon in human erythrocytes, J. Physiol. 113, 228-239 (1951).
Brochard, et al., Frequency spectrum of the flicker phenomenon in erythrocytes, J. Phys. (Paris) 36, 1035-1047 (1975).
Fricke, et al., Variation of frequency spectrum of the erythrocyte flickering caused by aging, osmolarity, temperature and pathological changes, Biochim. Biophys. Acta 803, 145-152 (1984).
Krol, et al., Local mechanical oscillations of the cell surface within the range 0.2-30 Hz, Eur. Biophys. J. 19, 93-99 (1990).
Popescu, et al., Observation of dynamic subdomains in red blood cells, J. Biomed. Opt. 11, 040503 (2006).
Krol, et al., The role of actin cytoskeleton in the generation of surface oscillations of red blood cell ghosts, Membr. Cell Biol. 14, 69-77 (2000).
Levin, et al., Membrane fluctuations in erythrocytes are linked to MgATP-dependent dynamic assembly of the membrane skeleton, Biophys J. 60, 733-737 (1991).
Tuvia, et al., Cell membrane fluctuations are regulated by medium macroviscosity: Evidence for a metabolic driving force, Proc. Natl. Acad. Sci. USA 94, 5045-5049 (1997).
Tuvia, et al., Mechanical Fluctuations of the Membrane-Skeleton Are Dependent on F-Actin ATPase in Human Erythrocytes, J. Cell. Biol. 141, 1551-1561 (1998).
Tuvia, et al., β-Adrenergic agonists regulate cell membrane fluctuations of human erythrocytes, J. Physiol. 516, 781-792 (1999).
Morariu, et al., Quarter power scaling in dynamics: experimental evidence from cell biology and cognitive psychology, Fluct. Noise Lett. 1, L111-L117 (2001).
Buchman, The community of the self, Nature 420, 246-251 (2002).
Goldberger, et al., Fractal dynamics in physiology: Alterations with disease and aging, Proc. Natl. Acad. Sci. USA 99, 2466-2472 (2002).
Costa, et al., Multiscale entropy analysis of physiologic time series, Phys. Rev. Lett. 89, 062102 (2002).
Costa, et al., Multiscale entropy analysis of biological signals, Phys. Rev. E 71, 021906 (2005).
Costa, et al., Noise and poise: Enhancement of postural complexity in the elderly with a stochastic-resonance-based therapy, Eur. Phys. Lett. 77, 68008 (2007).
Richman, et al., Physiological time-series analysis using approximate entropy and sample entropy, Am. J. Physiol. 278, H2039-H2049 (2000).
Griffin, et al., Heart Rate Characteristics: Novel Physiomarkers to Predict Neonatal Infection and Death, Pediatrics 116, 1070-1074 (2005).
D. E. Lake, IEEE Trans. Biomed. Eng. 53, 21 (2006).
Peng, et al., Quantification of scaling exponents and crossover phenomena in nonstationary heartbeat time series, Chaos 5, 82 (1995).
Koch, et al., Duration of Red-Cell Storage and Complications after Cardiac Surgery, N. Engl. J. Med. 358, 1229-1239 (2008).
Vera, et al., 3-D Nanomechanics of an Erythrocyte Junctional Complex in Equibiaxial and Anisotropic Deformations, Ann. Biomed. Eng. 33, 1387-1404 (2005).
Sultan, et al., A Computational Tensegrity Model Predicts Dynamic Rheological Behaviors in Living Cells, Ann. Biomed. Eng. 32, 520-530 (2004).
Rennie, et al., Human erythrocyte fraction in “Percoll” density gradients., Clin. Chim. Acta 98, 119-125 (1979).

There is a need for systems and methods for quantifying and analyzing a cell's physiologic complexity, which is represented by cellular flickering.

### BRIEF SUMMARY OF THE INVENTION

Provided herein are methods and systems for assessing cellular flickering. The methods include using a phase contrast microscope to obtain a plurality of images of a cell, digitizing and/or pixilating the plurality of images such that the plurality of images are segmented into an array of pixels, each pixel representing a portion of the cell, and measuring the intensity of movement of the portions of the cell represented by individual pixels. The methods further include calculating a complexity measure for the individual pixels based on the measured intensity of movements of the portions of the cell represented by the individual pixels. Such complexity measures can then be mapped and/or plotted in order to assess cellular flickering, and thereby assess biological function and other characteristics of the cell.

### BRIEF DESCRIPTION OF THE DRAWINGS/FIGURES

The patent or application file contains at least one drawing executed in color. Copies of this patent or patent application publication with color drawing(s) will be provided by the Office upon request and payment of the necessary fee.

The accompanying figures, which are incorporated herein and form part of the specification, together with the description, serve to illustrate and explain the principles of the invention and to enable one skilled in the pertinent art(s) to make and use the invention. In the drawings, generally, like reference numbers indicate identical or functionally or structurally similar elements. Additionally, generally, the leftmost digit(s) of a reference number identifies the drawing in which the reference number first appears.

FIG. 1 is a flow-chart illustrating a method of assessing cellular flickering in accordance with one embodiment presented herein.

FIG. 2 shows phase contrast images of new and old red blood cells (RBCs).

FIG. 3 shows time series plots of a small area in the membrane of a new and an old RBC.

FIG. 4 shows power spectrums for the time series plotted in FIG. 3.

FIG. 5 illustrates detrended fluctuation analyses (DFA) for the time series plots provided in FIG. 3.

FIG. 6 illustrates multiscale entropy (MSE) analyses for the two time series plots provided in FIG. 3.

FIG. 7 illustrates reconstituted maps of new and old RBCs under coefficient of variation analysis, DFA analysis, and MSE analysis.

FIG. 8 illustrates histograms from new and old RBCs resulting from DFA analysis and MSE analysis.

FIG. 9 illustrates an example computer system useful for implementing the methods presented herein.

### DETAILED DESCRIPTION OF THE INVENTION

Presented herein are methods and systems for assessing and analyzing cellular flickering. Also presented are various exemplary embodiments and applications for assessing and analyzing cellular flickering.

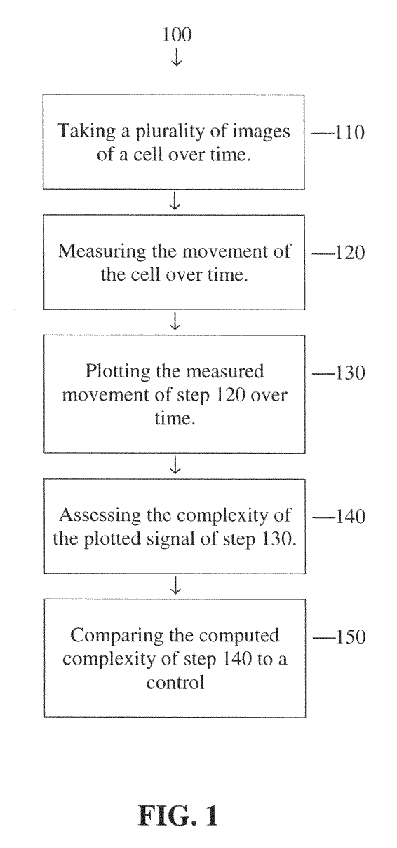

FIG. 1 is a flow-chart generally illustrating a method 100 of assessing cellular flickering. In step 110, a plurality of images are taken of a cell over time. In step 120, these images are analyzed to measure the movement of the cell over time. As used herein the phrase “movement of the cell” is not meant to signify a positional change of the entire cell, but is instead intended to signify the vibratory motions, or flickering, of the cellular membrane In step 130, the measured movements of contiguous areas of the cell are plotted over time. The term “plot” or “plotted,” as used herein, is not intended to be limited to the action of producing a visual representation of the data. One of skill in the art would recognize that the “plotting” step may be actualized by simply providing computer-based algorithms or programs that record, store, and/or assess the data for further processing without necessarily providing a visual representation of the data. In step 140, the signal plotted in step 130 is analyzed using complexity algorithms to assess the complex fluctuations of the signal. The use of the terms “signal” and/or “plotted signal” should be construed to mean the underlying data which is recorded, stored, and/or assessed, whether or not the underlying data is ultimately visually displayed. In step 150, the complexity of the signal is compared to a control. While FIG. 1 generally illustrates method 100, one of skill in the art will understand that method 100 may be actualized in many different configurations and alternative embodiments.

For example, in step 110, a plurality of images of a cell can be obtained using various imaging and microscopy techniques; such as, for example, contrast enhancement imaging and time delay integration techniques. In one embodiment, a phase contrast microscope is used to obtain sequential images of a cell over a given period of time. While various imaging techniques may be employed, phase contrast microscopy has the advantage of being able to take an image of a cell, digitize the image into an array of pixels, and thereafter measure the intensity of movement of the portion of the cell (or more specifically the cellular membrane) represented by each pixel. The movement of the cell is measured by, for example, the angular change over time of the portion of the cell within the representative pixel. In other words, as a cell flickers, portions of the cellular membrane move in various directions. Multiple digitized and pixilated images of the cell can then be used to quantify how the cellular membrane moves by analyzing the movements of the individual portions of the cellular membrane represented by the digitized pixels. As such, the phase contrast microscope is an efficient instrument for measuring the movement of the cell, as outlined by step 120. One of skill in the art would recognize that imaging systems equivalent to the phase contrast microscope may be employed to accomplish the methods and objectives presented and claimed herein.

Step 120 generally comprises measuring the movement of the cell over time. In step 130, the measurements of step 120 are plotted (or recorded, or stored). In the embodiment wherein a phase contrast microscope is employed, plots of the movement of the cell over time are created for each pixel. For example, if the phase contrast microscope takes images of the cell at a rate of 30 frames per second over 4 minutes, the microscope would thus obtain 7,200 images. If each image includes 40,000 pixels (i.e., in a 200×200 pixel array), the result of step 130 is 40,000 plots, each plot comprising a signal of 7,200 data points. These 40,000 signals are then further analyzed to determine their individual complex fluctuations. Alternative imaging and/or cellular movement measuring techniques may produce one or more signals for complexity analysis.

In step 140, the plotted signal(s) of step 130 are analyzed using complexity algorithms. Complexity algorithms are known to those skilled in the art. For example, in one embodiment, each signal plotted in step 130 can be analyzed by detrended fluctuation analyses (DFA). In an alternative embodiment, each signal plotted in step 130 can be analyzed by multiscale entropy (MSE) analysis. In another embodiment, each signal plotted in step 130 can be analyzed using time asymmetry measurements (time irreversibility). In yet another embodiment, each signal plotted in step 130 can be analyzed using information-based similarity measurements. The embodiments provided are merely examples.

In the exemplary embodiment wherein a phase contrast microscope is employed, and 40,000 signals are plotted, a measure of complexity for each of the 40,000 signals may be assessed. In other words, a measure of complexity for each pixel can be obtained. The 40,000 complexity measures may be scaled, indexed, and/or mapped to show concentrations of complex movements and/or uniformity or non-uniformity of complex movements over the cellular membrane. The complexity measures may also be plotted in a histogram to further analyze the frequency of complex versus non-complex movements.

Step 150 generally comprises comparing the computed complexity measures of step 140 to a control. For example, the complexity of the cellular flicker can be compared to a preset threshold value. In such instance, a determination may be made as to whether a cell is viable or non-viable based on predetermined complexity measures. Alternatively, the cellular flicker of a single cell may be measured before and after an event; such as, for example, a therapeutic intervention or storage in a medium or container. The comparison of the flicker complexity before and after the event will indicate whether the event has a positive, negative, or neutral effect on the viability and/or functionality of the cell.

For example, in the exemplary embodiment wherein a phase contrast microscope is employed, the complexity of the cellular flicker may be assessed before and after an event. The resulting complexity measures may be plotted in two histograms—one indicative of cellular viability/functionality before the event, and one indicative of cellular viability/functionality after the event. If comparison of the two histograms shows that the membrane flickering had higher complexity (for example, higher entropy values across multiscale scales and/or fractal exponents (alpha-DFA) closer to one) prior to the event, then such observation would indicate that the event had a negative effect on the viability/functionality of the cell. If, for example, the event were the administration of a pharmacologic agent (e.g., a drug), a decrease in global complexity of the cellular flickering would indicate that the drug has a negative or toxic effect on cellular function. In yet another embodiment, assessing the functionality/viability and potential toxicity (e.g., “storage legion”) of cells preserved in a storage container in a blood bank.

### Experimental Results

The inventors conducted laboratory experiments using detrended fluctuation analysis (DFA) and multiscale entropy (MSE) methods, to show that the short-term flickering motions of RBCs observed under phase contrast microscopy have a fractal scaling exponent close to 1/f noise and exhibit complex patterns over multiple time scales. Further, the inventors found that these dynamical properties degrade with in vivo aging such that older cells that have been in the circulation longer generate significantly (p<0.003) less complex flickering patterns than newly formed cells. The inventors assessed the dynamics of flickering in light of the following hypotheses: 1) the dynamics of RBC membrane fluctuations exhibit multiscale complexity; and 2) the dynamical properties of RBC membrane fluctuations change with in vivo aging—old cells generate less complex dynamical patterns than new cells.

The inventors analyzed time lapse phase contrast microscopy recordings of twenty-six fresh RBCs (thirteen new cells and thirteen old cells) from five healthy adult donors.

In preparation, fresh RBCs (5 ml) were obtained by venipuncture and diluted in a ratio of 1:10 in a Hank's buffer saline solution (HBSS) with Ca²⁺ and Mg²⁺, centrifuged at 1300×g for 5 min. The top layers containing white cells were removed along with the top 10% of the red cells. The washing was repeated three times following the same procedure. Separation of new and old (estimated age <10 and >70 days, respectively) RBCs was performed using centrifugation over Percoll as described in Rennie, et al., Human erythrocyte fraction in “Percoll” density gradients., Clin. Chim. Acta 98, 119-125 (1979). To acquire time-lapse images, the inventors used a HAMAMATSU ORCA AG CCD camera interfaced to an OLYMPUS BX62 microscope fitted with an UPLANAPO 100×1.35 phase contrast objective. The inventors recorded 5000 frames at 34 frames/s.

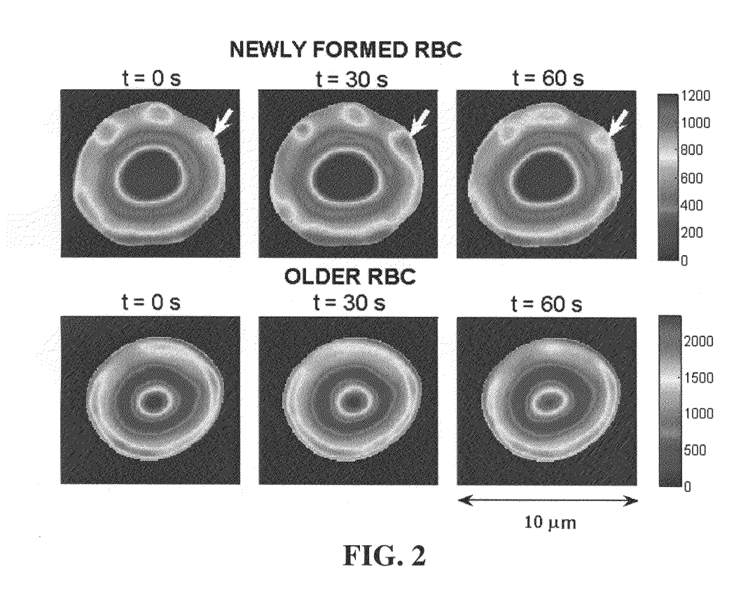

FIG. 2 shows phase contrast images of new and old RBCs. More specifically, FIG. 2 shows consecutive pseudo-colored phase contrast images (30 seconds apart) of a new RBC (top plots) and an old RBC (bottom plots). Each frame of FIG. 2 is a matrix of numerical values that represent the intensity of light passing through a particular region of the image (pixel size=0.0625 μm) at a given instant. Changes in the intensity of light (represented in color) are due to membrane oscillations. The top plots show the existence of multi-focal transient domains in the new cell. White arrows point to one of these domains of higher amplitude flickering. In contrast, such transient domains were not identified in the old cell. For representational purposes, the background and the “halo” surrounding the cell (a phase contrast imaging artifact) were removed.

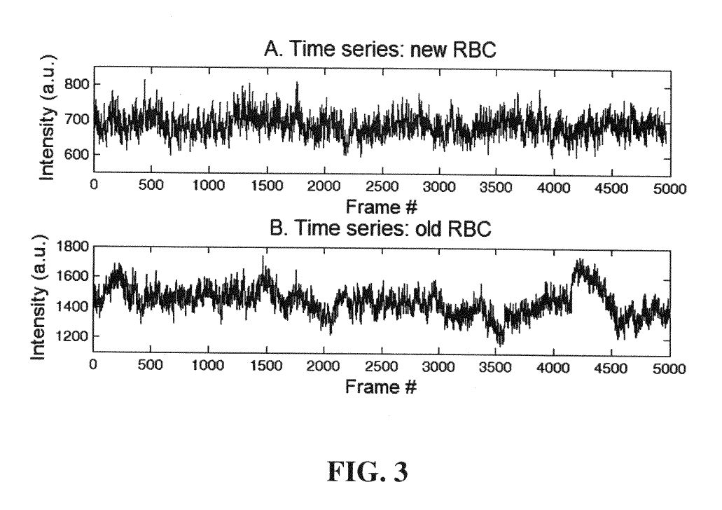

From the recording of consecutive frames, the time series of light intensity fluctuations for individual pixels were derived and plotted in FIG. 3, which shows the time series plots for the new RBC (top panel) and old RBC (bottom panel). Time series fluctuations represented in FIG. 3 were measured and plotted in arbitrary units (a.u.) and reflect changes in the light intensity that passes across the cell.

To quantify the overall dynamical complexity of RBC membrane flickering, for each pixel, a calculation was made of: 1) a fractal exponent using the DFA algorithm, a modified root mean square analysis of a random walk; and 2) a complexity index derived using the MSE method. These two algorithms quantify different, yet complementary, properties of complex signals.

The DFA algorithm measures the correlation properties of a signal. Briefly, the algorithm quantifies the relationship between F(η), the root mean square fluctuation of an integrated and detrended time series, and the observation window size, η. Typically, F(η) increases with window size according to F(η)˜nα. If α=0.5, the time series fluctuations represent uncorrelated randomness; if α=1 (1/f noise), the time series has long-range correlations and exhibits scale-invariant (fractal) properties; if α=1.5, the time series represents a random walk (Brownian motion). The DFA algorithm is described in more detail in Peng, et al., Quantification of scaling exponents and crossover phenomena in nonstationary heartbeat time series, Chaos 5, 82 (1995), which is herein incorporated by reference in its entirety.

The MSE method quantifies the degree of irregularity of a time series over a range of scales. Briefly, the method comprises three steps: 1) a coarse-graining procedure used to construct a set of derived time series representing the system's dynamics over a range of scales; 2) quantification of the degree of irregularity for each coarse-grained time series using an entropy measure (e.g., sample entropy); and 3) calculation of the complexity index. The sequence of entropy values for a range of scale is called the MSE curve. The MSE method is described in more detail in Costa, et al., Multiscale entropy analysis of physiologic time series, Phys. Rev. Lett. 89, 062102 (2002), which is hereby incorporated by reference in its entirety. For complex signals, such as 1/f noise time series, entropy is constant for all scales because at all levels of resolution the signal exhibits complex fluctuations. In contrast, for uncorrelated (white) noise time series, entropy monotonically decreases with scale because the signal contains maximum information for scale one and no new details (information) are revealed on larger scales. Therefore, not only the absolute values of entropy but also the profiles of the MSE curves should be taken into consideration to quantify the overall complexity of a time series.

A complexity index CI was calculated by integrating the entropy values over a pre-selected range of scales, multiplied by one or negative one depending on whether the slope of the MSE curve was positive or negative, respectively. In this study, the maximum scale selected was six, which was determined taking into consideration the length of the original time series.

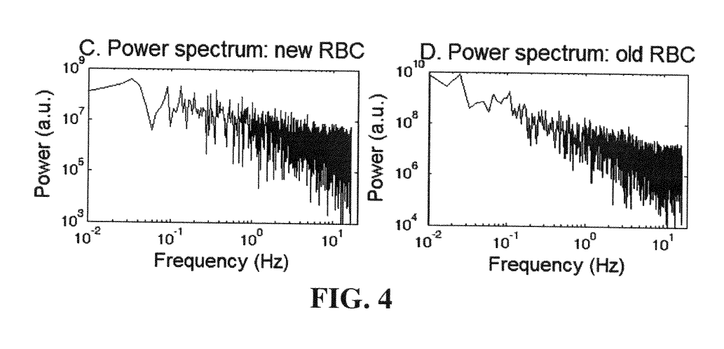

FIG. 4 shows power spectra for the time series plotted in FIG. 3. FIG. 4 shows an absence of a dominant (characteristic) frequency for the time series plotted in FIG. 3.

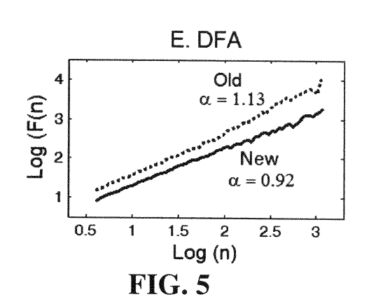

FIG. 5 shows the results of the DFA analysis for the two time series shown in FIG. 3. Note that the α (fractal) exponent for the old RBC is higher (closer to 1.5) than for the new RBC, indicating that the underlying dynamics of the former membrane is closer to Brownian motion than that of the latter, which shows scaling close to 1/f noise. Both time series exhibit long-range correlations (α exponents close to one over at least two orders of magnitude: log(n) ranging from one to three).

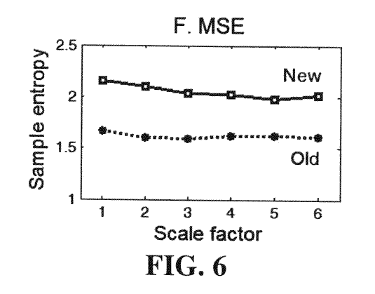

FIG. 6 shows the results of the MSE analysis for the two time series shown in FIG. 3. The entropy measure (sample entropy) is higher for the new RBC than for the old RBC over time scales ranging from 0.029 (scale factor one) to 0.174 sec (scale factor six). (Since the sampling frequency is 34 Hz, the scale factor increments by steps of 1/34=0.029 s.) Further, the entropy values are approximately the same for all time scales analyzed, for both the new and the old cells, which is typical of time series with long-range correlations.

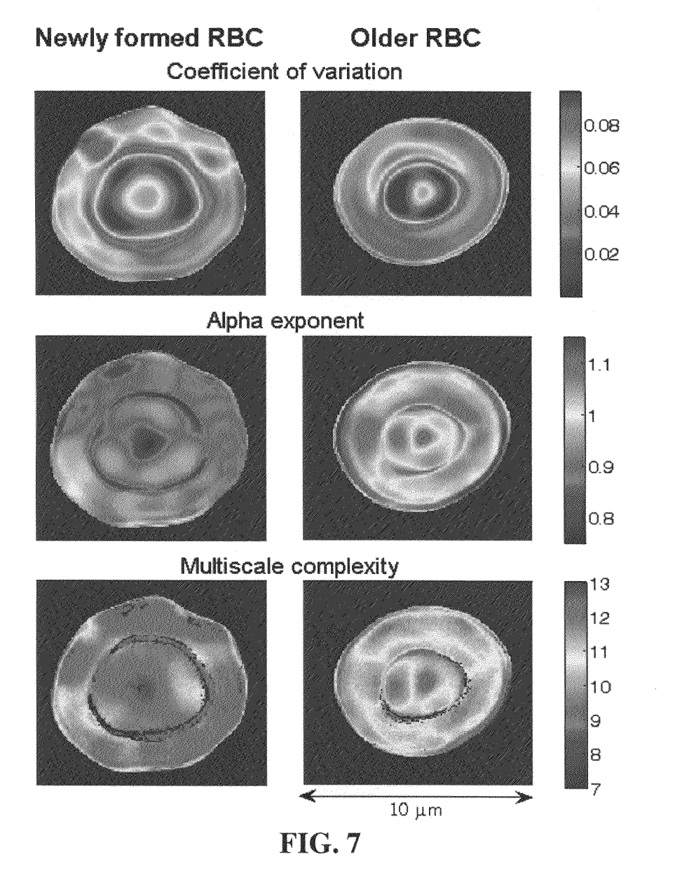

FIG. 7 illustrates reconstituted maps of new and old RBCs under coefficient of variation analysis (top panel), DFA analysis (middle panel), and MSE analysis (bottom panel). In FIG. 7, the top panels show the coefficient of variation (standard deviation divided by mean value) maps for the analyzed new RBC (left image) and old RBC (right image). The top panels show that the new cell has a more heterogeneous pattern of fluctuation. The middle plots show the α (fractal) exponent maps calculated using DFA. The bottom plots show the complexity maps calculated using the MSE method. Values of the parameters used to calculate sample entropy were m=2 and r=0.15.

The complexity index was obtained by integrating the values of entropy between scales one and six, inclusively. Colors were arbitrarily chosen to code the amplitude of the measured variable and visually display the values in constructed maps. To construct the maps, the inventors analyzed the time series of individual pixels (presented in FIG. 3), each of which comprises 5000 data points. The maps of the coefficient of variation show that the membrane of new RBCs displays different domains of activity. In contrast, old cells appear more homogeneous. The maps show that towards the end of the RBC circulatory life, the dynamical properties of membrane fluctuations are closer to Brownian motion (α=1.5) than at the beginning. Consistent with these results, multiscale complexity maps show that the membrane dynamics of new RBCs are more complex than those of old RBCs.

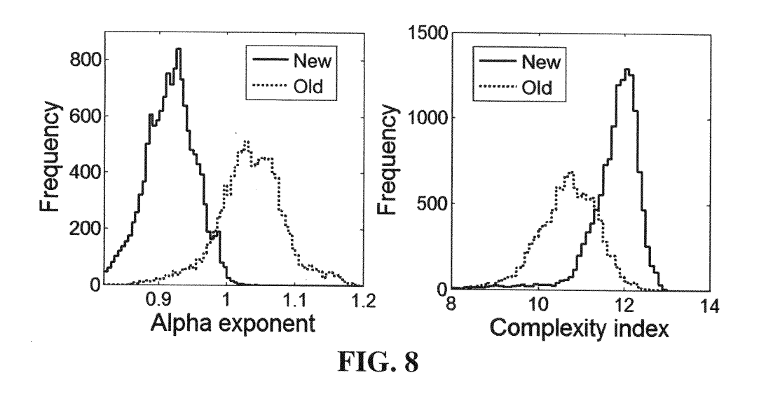

To facilitate the comparison between the two cells, FIG. 8 presents the histograms of the α exponent and the C_{I}, for both the new RBC and the old RBC. The α exponents are higher for the old cell than for the new cell, indicating that with in vivo aging, the dynamical properties of the flickering change towards Brownian motion. The exponents vary approximately between 0.8 and 1.0 for the new cell, and between 0.9 and 1.2 for the old cell. These relatively tight intervals support the robustness of the findings and are not unexpected since the membrane is scaffolded to an inter-connected cytoskeleton.

Multiscale complexity maps, as shown in the bottom panels of FIG. 7, show that the time series from the new cell are more complex than those of the old cell for the range of time scales analyzed (0.029-0.176 s).

Results obtained for the overall cell population studied (presented in Table 1 below) are consistent with those presented for the two representative cells in FIGS. 2 8. Table I presents the dynamical measures computed for the new (N=13) and old (N=13) RBCs. Measure α_{I} is the percentage of pixels with scaling exponent α>1, which indicates dynamical properties closer to Brownian noise. Measure C_{I}, is the complexity index (unitless) obtained by integrating the sample entropy values between scales 1 and 6. Values are given as mean±SD. The p values were calculated using the Mann-Whitney test.

TABLE I

| Measure | New RBCs | Old RBCs | p value |
|---|---|---|---|
| α₁(%) | 2.4 ± 3.4 | 21.8 ± 16.6 | 2 × 10−4 |
| C₁ | 11.6 ± 0.32 | 10.1 ± 0.40 | 3 × 10−3 |

Of note, both the α exponent and the CI independent of the time series variance. Their values are determined solely by the correlations among the data points and the richness of the dynamical structures. To the extent that the non-cellular background is uncorrelated (white) noise of lower amplitude than the flickering, qualitatively similar results for the DFA and MSE analyses are obtained whether or not the background is subtracted from the time series of individual pixels. The inventors also verified that averaging adjacent pixels (e.g., 3×3 squares) did not qualitatively change the results. The results are notable for the following findings: 1) flickering of the human RBC membrane, especially in newly formed cells, shows robust long-range correlations, consistent with a scale-free pattern, and a high degree of multiscale complexity; 2) dynamical complexity degrades with in vivo aging of the RBCs, evidenced by significantly lower MSE values and by a change in the α exponent towards a more Brownian pattern; and 3) degradation of complexity at the cellular level with in vivo aging supports the more general concept of multiscale complexity loss with aging and disease at all levels of biologic organization. Furthermore, the inventors have presented a new way of mapping spatial fluctuations onto time series that can be subjected to rigorous complexity analyses using a number of techniques, including MSE and DFA.

From a practical viewpoint, recording and analysis of complex RBC membrane oscillations may lead to a robust high-throughput means to screen for improved blood storage conditions and novel interventions that yield more viable and functional RBCs for transfusion. The dynamical analyses that are presented here may also provide a way of assessing drug toxicity.

### Exemplary Computer System Implementation

The embodiments presented may be implemented in hardware, firmware, software, or combinations thereof. In such an embodiment, portions of the various components and steps of the methods presented would be implemented in hardware, firmware, and/or software to perform the functions presented. That is, the same piece of hardware, firmware, or module of software could perform one or more of the illustrated methods (i.e., components or steps).

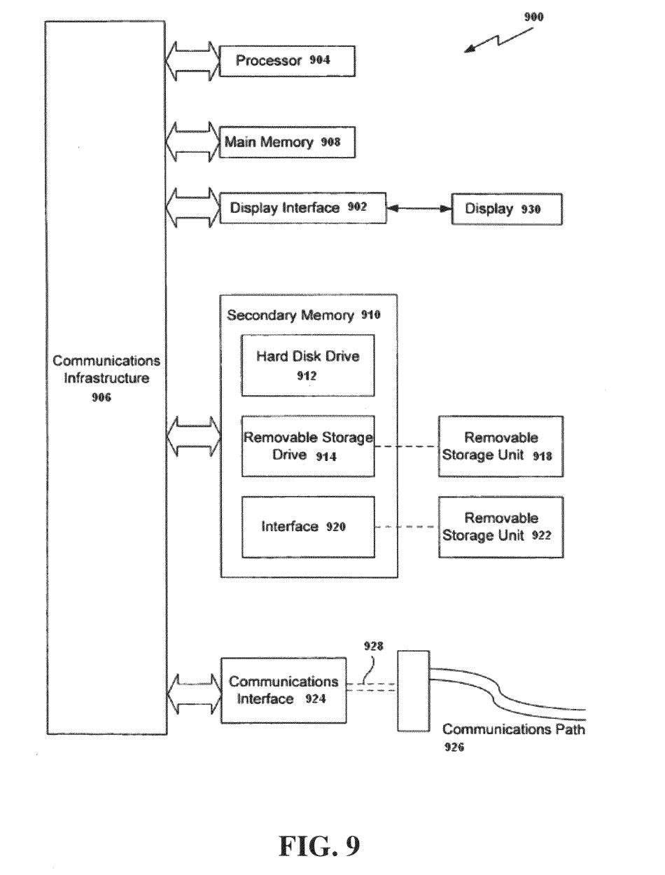

For example, the presented embodiments may be implemented in one or more computer systems capable of carrying out the functionality described herein. Referring to FIG. 9, an example computer system 900 useful in implementing the presented embodiments is shown. After reading this description, it will become apparent to one skilled in the relevant art(s) how to implement the presented embodiments using other computer systems and/or computer architectures.

The computer system 900 includes one or more processors, such as processor 904. The processor 904 is connected to a communications infrastructure 906 (e.g., a communications bus, crossover bar, or network).

Computer system 900 can include a display interface 902 that forwards graphics, text, and other data from the communications infrastructure 906 (or from a frame buffer not shown) for display on the display unit 930.

Computer system 900 also includes a main memory 908, preferably random access memory (RAM), and can also include a secondary memory 910. The secondary memory 910 can include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software (e.g., programs or other instructions) and/or data.

In alternative embodiments, secondary memory 910 can include other similar means for allowing computer software and/or data to be loaded into computer system 900. Such means can include, for example, a removable storage unit 922 and an interface 920. Examples of such can include a program cartridge and cartridge interface (such as that found in video game devices), a removable memory chip (such as an EPROM, or PROM) and associated socket, and other removable storage units 922 and interfaces 920, which allow software and data to be transferred from the removable storage unit 922 to computer system 900.

Computer system 900 can also include a communications interface 924. Communications interface 924 allows software and data to be transferred between computer system 900 and external devices. Examples of communications interface 924 can include a modem, a network interface (such as an Ethernet card), a communications port, a PCMCIA slot and card, etc. Software and data transferred via communications interface 924 are in the form of signals 928 which can be electronic, electromagnetic, optical, or other signals capable of being received by communications interface 924. These signals 928 are provided to communications interface 924 via a communications path (i.e., channel) 926. Communications path 926 carries signals 928 and can be implemented using wire or cable, fiber optics, a phone line, a cellular phone link, an RF link, free-space optics, and/or other communications channels.

In this document, the terms “computer program medium” and “computer usable medium” are used to generally refer to media such as removable storage unit 918, removable storage unit 922, a hard disk installed in hard disk drive 912, and signals 928. These computer program products are means for providing software to computer system 900. The invention is directed to such computer program products.

Computer programs (also called computer control logic or computer readable program code) are stored in main memory 908 and/or secondary memory 910. Computer programs can also be received via communications interface 924. Such computer programs, when executed, enable the computer system 900 to implement the presented embodiments. In particular, the computer programs, when executed, enable the processor 904 to implement steps of method 100 and alternative embodiments. Accordingly, such computer programs represent controllers of the computer system 900.

In an embodiment where the presented embodiments are implemented using software, the software can be stored in a computer program product and loaded into computer system 900 using removable storage drive 914, hard drive 912, interface 920, or communications interface 924. The control logic (software), when executed by the processor 904, causes the processor 904 to perform the functions of the presented embodiments.

In another embodiment, the presented embodiments are implemented primarily in hardware using, for example, hardware components such as application specific integrated circuits (ASICs). Implementation of the hardware state machine so as to perform the functions described herein will be apparent to one skilled in the relevant art(s). In yet another embodiment, the presented embodiments are implemented using a combination of both hardware and software.

The foregoing description of the specific embodiments will so fully reveal the general nature of the invention that others can, by applying knowledge within the skill of the art (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments.

### EXAMPLES

### Example 1

A method comprising: obtaining a plurality of images of a cell; measuring the movement of the cell over time based on the plurality of images; and calculating a measure of complexity based on the measured movements of the cell. The method may further comprise comparing the calculated measure of complexity to a control.

### Example 2

A method comprising: measuring the movement of a cellular membrane; and measuring the complexity of the movement of the cellular membrane.

### Example 3

A method comprising: obtaining a plurality of images of a cellular membrane; digitizing and/or pixilating the images; measuring the cellular flickering of the membrane within the digitized and/or pixilated region of the image; plotting (or recording, or storing) the measured cellular flicker for each digitized and/or pixilated region of the image; calculating a measure of complexity for each plot. The method may further comprise plotting the calculated complexity measures in a histogram.

### Example 4

A method comprising: obtaining a plurality of images of a cellular membrane; digitizing and/or pixilating the images; measuring the cellular flickering of the membrane within the digitized and/or pixilated region of the image; plotting (or recording, or storing) the measured cellular flicker for each digitized and/or pixilated region of the image; calculating a measure of complexity for each plot; indexing each measure of complexity; mapping the indexed complexity measures for each digitized and/or pixilated region of the image.

### Example 5

Any of the methods provided herein wherein the measure of complexity is calculated by DFA, MSE, information-based similarity measurements, and/or time asymmetry/irreversibility measurements.

### Example 6

A method comprising using any of the above-described methods to assess cellular viability.

### Example 7

A method comprising using any of the above-described methods to assess cellular function.

### Example 8

A method comprising using any of the above-described methods to quantify cellular membrane flickering.

### Example 9

A method comprising using any of the above-described methods to evaluate blood storage effects and provide a possible biomarker(s) of the blood storage lesion, to diagnose cellular pathology, to evaluate the health of a cell, to determine the functional age of a cell, to assess the effect of an event has on a cell, to assess the toxicity of a pharmacological agent/drug, and/or to test stored blood.

What is claimed is:

1. A method of assessing cellular flickering, comprising:
using a phase contrast microscope to obtain a plurality of images of a cell;
digitizing the plurality of images such that the plurality of images are segmented into an array of pixels, each pixel representing a portion of the cell;
measuring changes in pixel intensity that reflect vibratory motions of the portions of the cell represented by individual pixels; and
calculating complexity measures for individual pixels based on the measured changes in pixel intensity.

2. The method of claim 1, further comprising:
mapping the complexity measures for the individual pixels.

3. The method of claim 1, further comprising:
plotting the complexity measures for the individual pixels in a histogram.

4. The method of claim 1, wherein the step of calculating complexity measures for individual pixels further includes performing a detrended fluctuation analysis.

5. The method of claim 1, wherein the step of calculating complexity measures for individual pixels further includes performing a multiscale entropy analysis.

6. The method of claim 1, wherein the step of calculating complexity measures for individual pixels further includes performing an information-based similarity analysis.

7. The method of claim 1, wherein the step of calculating complexity measures for individual pixels further includes performing a time asymmetry analysis.

8. The method of claim 1, wherein the method is used to assess cellular viability.

9. The method of claim 1, wherein the method is used to test stored blood.

10. A method of assessing cellular flickering, comprising:
using a contrast imaging system to obtain a plurality of images of a cell;
pixelating the plurality of images, wherein the pixilated images form an array of pixels representing segmented portions of a cell over time;
measuring changes in pixel intensity that reflect vibratory motions of the segmented portions of the cell; and
calculating complexity measures for the segmented portions of the cell based on the measured changes in pixel intensity.

11. The method of claim 10 further comprising:
mapping the complexity measures for the individual pixels.

12. The method of claim 10, further comprising:
plotting the complexity measures for the individual pixels in a histogram.

13. The method of claim 10, wherein the step of calculating complexity measures for individual pixels further includes performing a detrended fluctuation analysis.

14. The method of claim 10, wherein the step of calculating complexity measures for individual pixels further includes performing a multiscale entropy analysis.

15. The method of claim 10, wherein the step of calculating complexity measures for individual pixels further includes performing an information-based similarity analysis.

16. The method of claim 10, wherein the step of calculating complexity measures for individual pixels further includes performing a time asymmetry analysis.

17. The method of claim 10, wherein the method is used to assess cellular viability.

18. The method of claim 10, wherein the method is used to test stored blood.

19. A computer program product comprising a computer useable medium having computer readable program code functions embedded in the medium for causing a computer to assess cellular flickering, comprising:
a first computer readable program code function that causes the computer to pixilate a plurality of images received from a contrast imaging system, wherein the pixilated images form an array of pixels representing portions of a cell;
a second computer readable program code function that causes the computer to measure changes in pixel intensity that reflect vibratory motions of the portions of the cell represented by individual pixels; and
a third computer readable program code function that causes the computer to calculate complexity measures for individual pixels based on the measured changes in pixel intensity.
